(19) United States
(12) Patent Application Publication
(10) Pub. No.: US 2023/0088244 A1
(43) Pub. Date: Mar. 23, 2023

(54) Common Interface for Supporting Virtualized Architectures

(71) Applicant: ServiceNow, Inc., Santa Clara, CA (US)

(72) Inventors: Prateek Bansal, Hyderabad (IN); Srinivas Ramanujaiah, Hyderabad (IN); Usha Sri Ramidi, Hyderabad (IN); Saurabh Dewan, Hyderabad (IN)

(21) Appl. No.: 17/479,212

(22) Filed: Sep. 20, 2021

(51) Int. Cl. G06F 9/455; G06F 16/22

(52) U.S. Cl. CPC G06F 9/45558; G06F 16/2282; G06F 2009/45595

(57) ABSTRACT

Persistent storage contains a plurality of configuration items characterizing attributes of a virtualized architecture and containing representations of relationships between the plurality of configuration items. One or more processors may be configured to: obtain, by way of a common interface, specifications of respective locations in the persistent storage that maintain sets of configuration items representing clusters, hosts, and virtual machines of the virtualized architecture; obtain, by way of the common interface, one or more scripts that are executable to retrieve the sets of configuration items from the persistent storage; apply, by a client application, the specifications of the respective locations to the scripts; and retrieve, by way of the client application executing the scripts, the sets of configuration items representing the clusters, the hosts, and the virtual machines of the virtualized architecture from the respective locations and a subset of the relationships between the sets of the configuration items.

### BACKGROUND

Modern computing systems are employing more and more virtualization. A virtual machine may be an instance of an operating system that can share a physical host computer with one or more other virtual machines. These physical hosts can be arranged into clusters. While virtualization allows fine-grained control over the allocation of tasks to virtual machines, there are multiple types of virtualization technologies that may represent relationships between virtual machines, hosts, and/or clusters in various ways. Currently, client applications that need to be aware of these relationships have to be specifically coded to support each of these virtualization technologies.

### SUMMARY

The embodiments herein address these problems and others by providing a common interface and framework through which virtualization relationships can be queried and identified. This interface can be any form of application programming interface (API), representational state transfer (REST) interface, function call, or script-based interface, for example. The common interface may provide information regarding virtualization relationships, such as a database query or database view result listing virtual machines per host and/or hosts per cluster in a set of columns, and metadata mapping column names to the semantic meanings of their contents.

In this manner, support for a new virtualization technology can be made available for multiple client applications in hours or days of effort by extending the interface. In contrast, coding specific support for the virtualization technology into such client applications can take weeks or months of effort.

Accordingly, a first example embodiment may involve persistent storage containing a plurality of configuration items characterizing attributes of a virtualized architecture and also containing representations of relationships between the plurality of configuration items, wherein the virtualized architecture is disposed within a managed network or a public cloud computing system. One or more processors configured to: obtain, by way of a common interface, specifications of respective locations in the persistent storage that maintain sets of configuration items representing clusters, hosts, and virtual machines of the virtualized architecture, wherein each of the hosts is disposed within one of the clusters, and wherein each of the virtual machines is disposed within one of the hosts; obtain, by way of the common interface, one or more scripts that are executable to retrieve the sets of configuration items from the persistent storage; apply, by a client application, the specifications of the respective locations to the one or more scripts; and retrieve, by way of the client application executing the one or more scripts, the sets of configuration items representing the clusters, the hosts, and the virtual machines of the virtualized architecture from the respective locations and a subset of the relationships between the sets of the configuration items.

A second example embodiment may involve storing, in persistent storage, a plurality of configuration items characterizing attributes of a virtualized architecture and also containing representations of relationships between the plurality of configuration items. The second example embodiment may also involve obtaining, by way of a common interface, specifications of respective locations in the persistent storage that maintain sets of configuration items representing clusters, hosts, and virtual machines of the virtualized architecture, wherein each of the hosts is disposed within one of the clusters, and wherein each of the virtual machines is disposed within one of the hosts. The second example embodiment may also involve obtaining, by way of the common interface, one or more scripts that are executable to retrieve the sets of configuration items from the persistent storage. The second example embodiment may also involve applying, by a client application, the specifications of the respective locations to the one or more scripts. The second example embodiment may also involve retrieving, by way of the client application executing the one or more scripts, the sets of configuration items representing the clusters, the hosts, and the virtual machines of the virtualized architecture from the respective locations and a subset of the relationships between the sets of the configuration items.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6 depicts a virtualized cluster, in accordance with example embodiments.

FIG. 7 depicts several virtualized architectures, in accordance with example embodiments.

FIG. 8A depicts discovery and use of configuration items related to a virtualized architecture, in accordance with example embodiments.

FIG. 8B depicts metadata specifying locations of configuration items and/or attributes thereof, in accordance with example embodiments.

FIG. 9 depicts a client application interacting with configuration items, in accordance with example embodiments.

FIG. 10 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. EXAMPLE COMPUTING DEVICES AND CLOUD-BASED COMPUTING ENVIRONMENTS

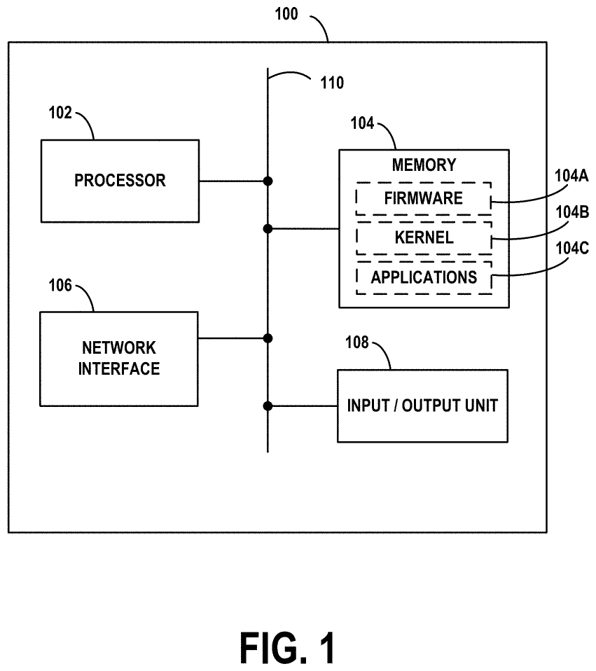

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

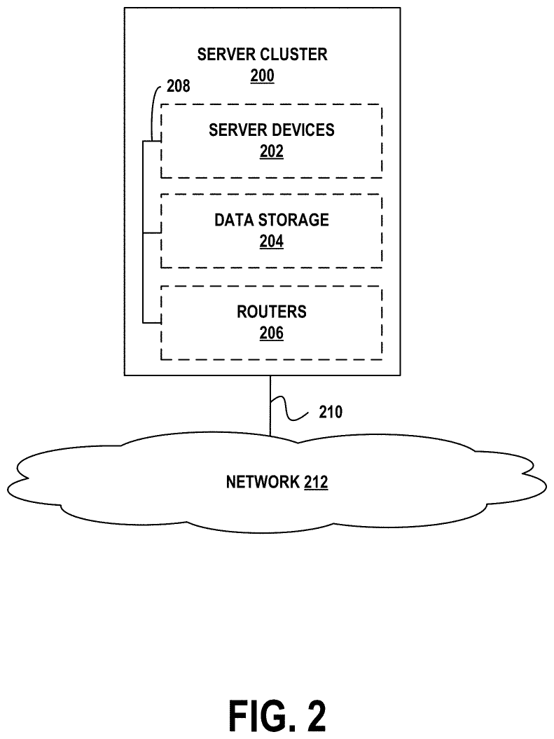

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. EXAMPLE REMOTE NETWORK MANAGEMENT ARCHITECTURE

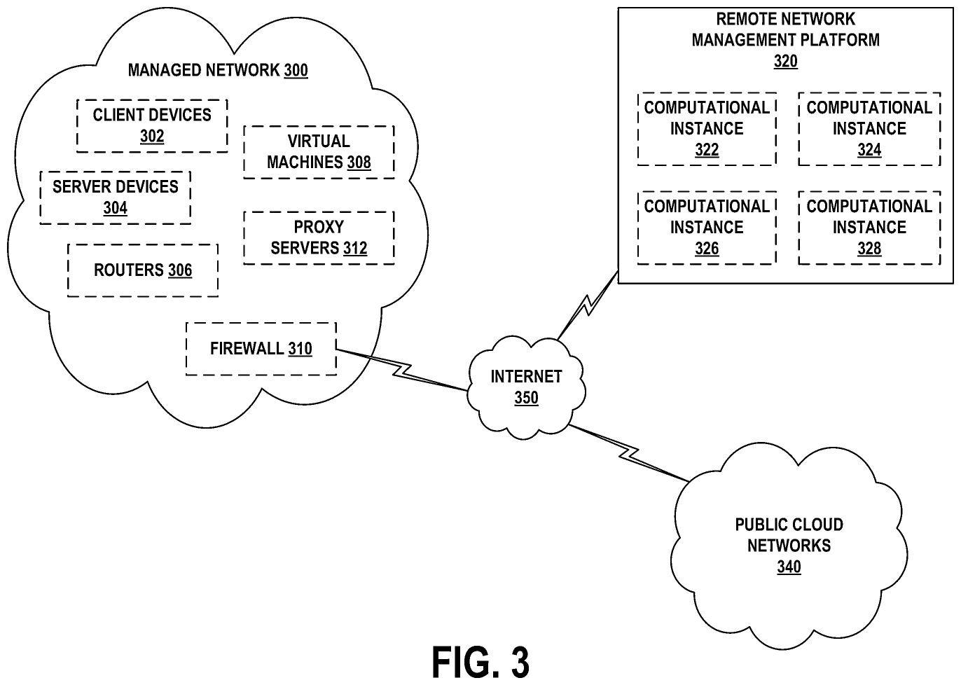

FIG. 3 depicts a remote network management architecture, in accordance with example embodiments. This architecture includes three main components—managed network 300, remote network management platform 320, and public cloud networks 340—all connected by way of Internet 350.

A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and Other Operations

Internet 350 may represent a portion of the global Internet. However, Internet 350 may alternatively represent a different type of network, such as a private wide-area or local-area packet-switched network.

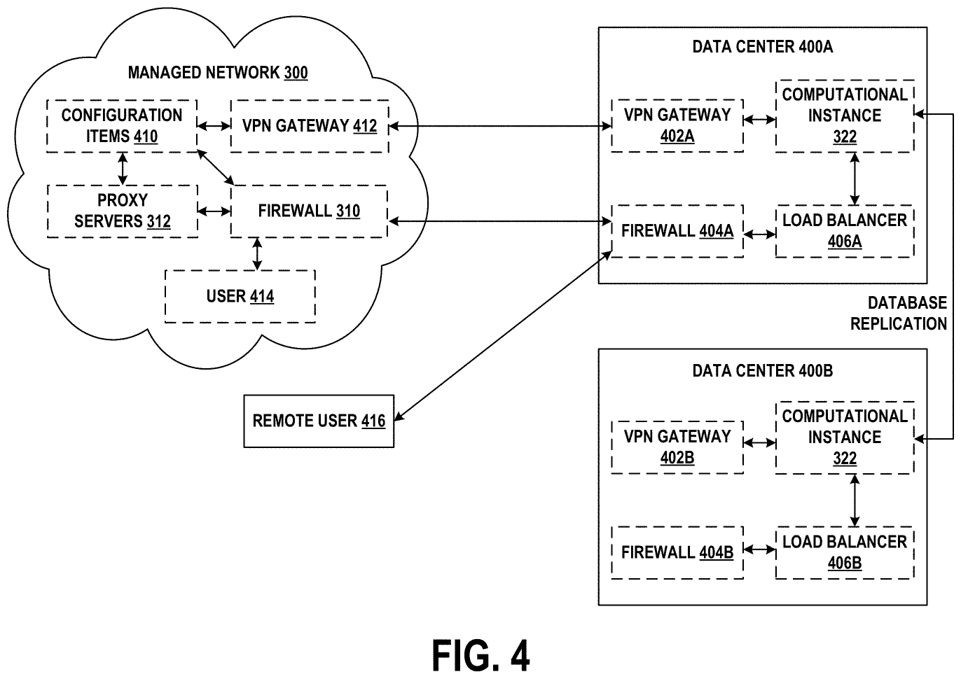

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. EXAMPLE DEVICE, APPLICATION, AND SERVICE DISCOVERY

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

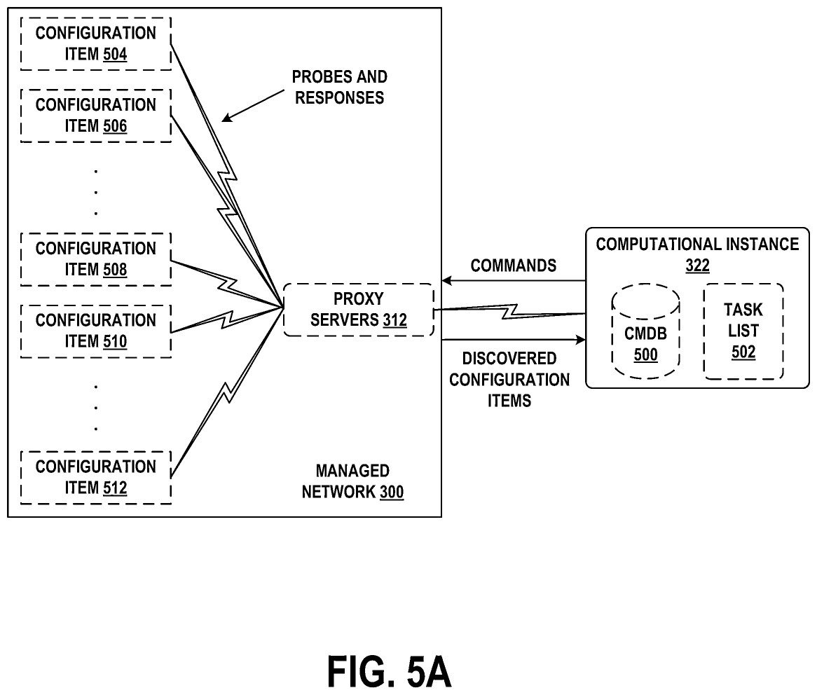

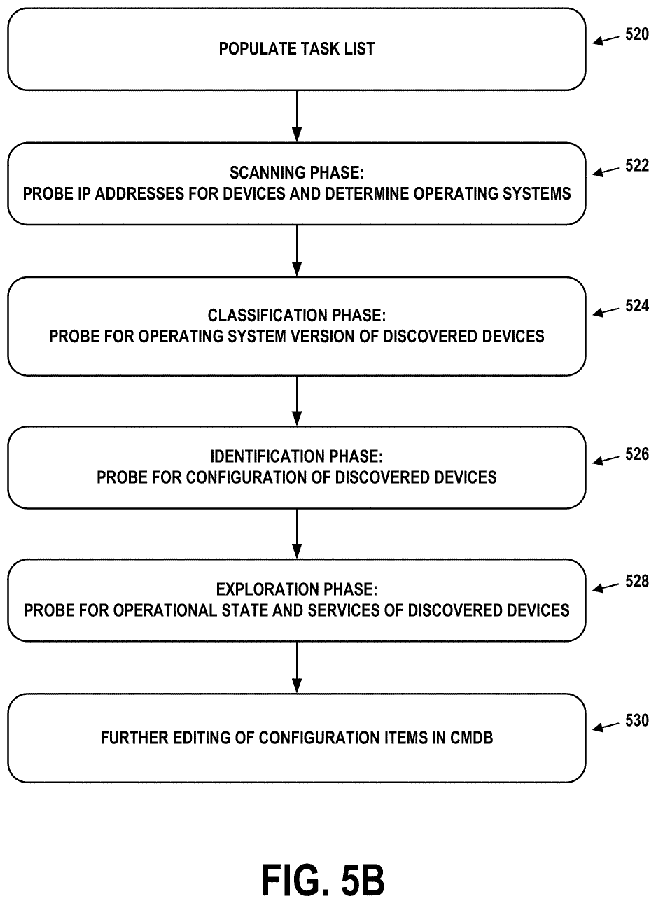

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. EXAMPLE VIRTUALIZED ARCHITECTURES AND DISCOVERY THEREOF

As noted above, enterprises are rapidly moving toward virtualized deployments of software applications. Server applications in particular, such as but not limited to email servers, database servers, and directory servers, are being moved from bare metal servers (e.g., physical hosts with one or more applications employed by a particular set of users) to virtualized architectures in order to simplify operations and reduce cost.

For purposes of this discussion, server operating systems may be considered a type of software application that can be virtualized. Further, the term “VM” may refer to a virtual machine and the term “host” may refer to a physical host.

These virtualized architectures may reside in a managed network (e.g., managed network 300) or one or more public cloud systems (e.g., public cloud networks 340, also referred to as “cloud computing systems”). Further, different virtualized architectures may take different forms, with varying types of relationships between their constituent components. However, at some level, most virtualized architectures support a logical cluster of one or more hosts, and one or more virtual machines may be deployed on each of these hosts. Some virtualized architectures have controller nodes that maintain a representation of the cluster and its components, while others might not.

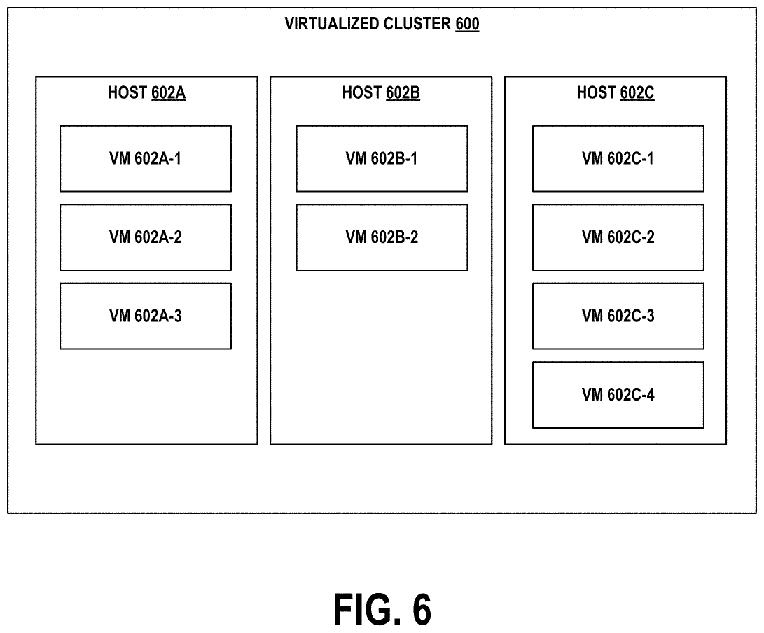

FIG. 6 provides an example of this hierarchy. Virtualized cluster 600 contains hosts 602A, 602B, and 602C. Host 602A contains VMs 602A-1, 602A-2, and 602A-3. Host 602B contains VMs 602B-1 and 602B-2. Host 602C contains VMs 602C-1, 602C-2, 602C-3, and 602C-4. Other examples are possible.

Discovery of these components, the relationships therebetween, and the representation of each as configuration items in a CMDB, typically involves the use of discovery patterns. Each discovery pattern is a script and/or a sequence of commands, queries, or other activities that probe various aspects of a virtualized architecture. Discovery patterns may be executed by a proxy server within a managed network, a computing device with a remote network management platform, other devices, or some combination thereof. Alternatively, the embodiments herein may be integrated with third-party discovery tools.

For example, a discovery pattern may query a REST interface of a virtualization cluster to obtain attributes relating to this cluster, including a list of IP addresses of hosts therein. The discovery pattern could then query another REST interface of the virtualization cluster or of the individual IP addresses in order to obtain attributes relating to the hosts, as well as lists of VMs on each. The discovery pattern could also query yet another REST interface of the virtualization cluster or those of the hosts or VMs to obtain attributes relating to the VMs. The discovery pattern may store, in the CMDB, the discovered components (cluster, hosts, VMs) with their associated attributes as configuration items. The discovery pattern may also store, in the CMDB, relationships between these configuration items. Such relationships may be explicit or inferred by the discovery pattern. Additionally, each VM may be probed by the same or a different discovery pattern to determine the software applications installed and/or executing on each VM.

But given the disparate nature of different virtualized architectures, these configuration items and relationships end up being stored in different structures of the CMDB. Some virtualized architectures can be effectively represented in existing CMDB tables, while new CMDB tables are created for other virtualized architectures. As a consequence, configuration items and relationships representing each type of virtualized architecture may be stored in a different fashion.

This creates a problem for client applications that seek to ingest, analyze, and/or report on these configuration items and relationships. Particularly, in current systems, each such client application needs to be coded to query different sets of CMDB tables for each virtualized architecture. This means that each time a new virtualized architecture is supported, these client applications need to be updated in order to be able to read its representations in the CMDB. Doing so results in weeks or months of development and test effort to fully support a new virtualized architecture across the client applications of a remote network management platform.

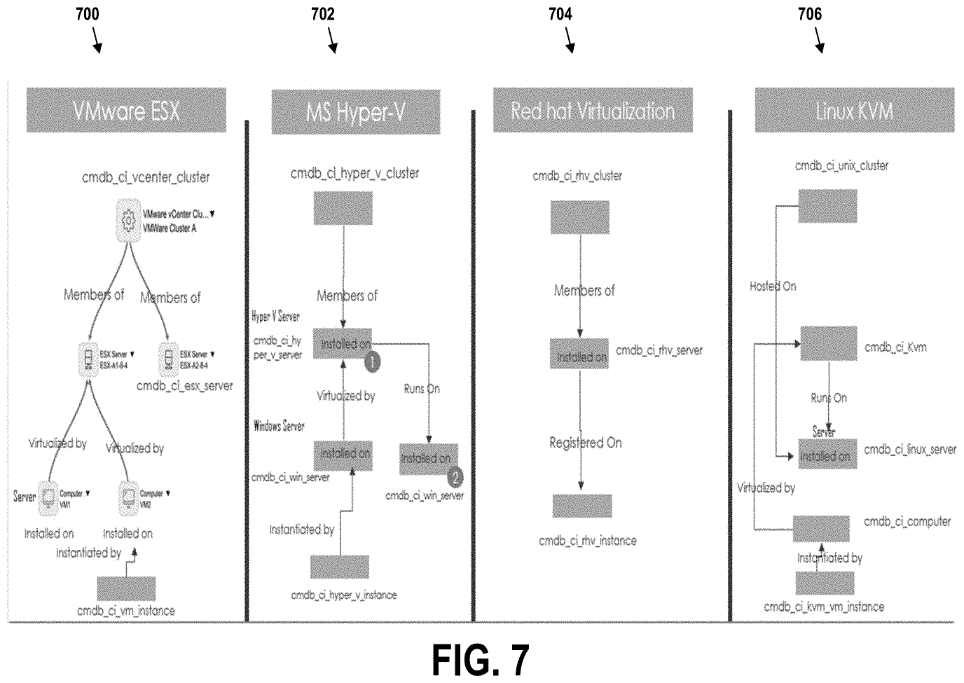

To illustrate the extent of this issue, FIG. 7 illustrates diagrams of the database schema representing four different types of virtualized architectures. Each of the schema shown in FIG. 7 has been simplified for purposes of example.

Virtualized architecture 700 depicts VMware ESX. Each row of CMDB table cmdb_ci_vcenter_cluster contains discovered attributes relating to a VMware ESX cluster. Each row of CMDB table cmdb_ci_esx_server contains discovered attributes relating to installations of VMware ESX software in a VMware ESX cluster, and has a “members of” relationship with its parent cluster in CMDB table cmdb_ci_vcenter_cluster. Each row of CMDB table cmdb_ci_vm_instance contains discovered attributes relating to a VM of a VMware ESX cluster and has a “registered on” relationship with its parent VMware ESX software.

Not explicitly shown in virtualized architecture 700 is a further CMDB table (which could have various names, such as cmdb_ci_server) that contains discovered attributes relating to hosts in a VMware ESX cluster. These hosts may have “virtualized by” relationships with the installations of the VMware ESX software represented in CMDB table cmdb_ci_esx_server. Additionally, the VMs represented in CMDB table cmdb_ci_vm_instance may have “instantiated by” relationships with the hosts represented in the further CMDB table.

Virtualized architecture 702 depicts MS-Hyper-V. Each row of CMDB table cmdb_ci_hyper_v_cluster contains discovered attributes relating to an MS-Hyper-V cluster. Each row of CMDB table cmdb_ci_hyper_v_server contains discovered attributes relating to installations of MS-Hyper-V software in an MS-Hyper-V cluster, and has a “members of” relationship with its parent cluster in CMDB table cmdb_ci_hyper_v_cluster. Each row of CMDB table cmdb_ci_hyper_v_instance contains discovered attributes relating to a VM of a MS-Hyper-V cluster and has a “registered on” relationship with its parent VMware ESX software.

Also shown in virtualized architecture 702 is CMDB table cmdb_ci_win_server that contains discovered attributes relating to hosts in an MS-Hyper-V cluster, and that these hosts may have “virtualized by” relationships with the installations of the MS-Hyper-V software represented in CMDB table cmdb_ci_hyper_v_server. Additionally, the VMs represented in CMDB table cmdb_ci_hyper_v_instance may have “instantiated by” relationships with the hosts represented in the CMDB table cmdb_ci_win_server.

Virtualized architecture 704 depicts Red Hat Virtualization. Each row of CMDB table cmdb_ci_rhv_cluster contains discovered attributes relating to a Red Hat Virtualization cluster. Each row of CMDB table cmdb_ci_rhv_server contains discovered attributes relating to hosts in a Red Hat Virtualization cluster, and has a “members of” relationship with its parent cluster in CMDB table cmdb_ci_rhv_cluster. Each row of CMDB table cmdb_ci_rhv_instance contains discovered attributes relating to a VM of a Red Hat Virtualization cluster and has a “registered on” relationship with its parent host from CMDB table cmdb_ci_rhv_server.

Virtualized architecture 706 depicts Linux KVM Virtualization. Each row of CMDB table cmdb_ci_unix_cluster contains discovered attributes relating to a UNIX cluster (as Linux is a variation of UNIX, Linux clusters can be placed in this table). Each row of CMDB table cmdb_ci_kvm contains discovered attributes relating to installations of Linux KVM software in a Linux KVM Virtualization cluster. Each row of CMDB table cmdb_ci_linux_server contains discovered attributes relating to hosts in a Linux KVM Virtualization cluster, and has a “hosted on” relationship with its parent cluster in CMDB table cmdb_ci_unix_cluster.

Each row of table cmdb_ci_computer that references a physical computer in the cluster has a “virtualized by” relationship with installations of Linux KVM software in CMDB table cmdb_ci_kvm. Each row of CMDB table cmdb_ci_kvm_vm_instance contains discovered attributes relating to a VM of a Linux KVM Virtualization cluster and has an “instantiated by” relationship with hosts from CMDB table cmdb_ci_computer.

Additionally, there are other virtualized architectures aside from those specified in FIG. 7. Thus, VMware ESX, MS-Hyper-V, Red Hat Virtualization, and Linux KVM Virtualization are thus examples, and other virtualized architectures (each potentially with its own unique database tables and content thereof) may be used.

These disparate architectures and CMDB database schema demonstrate how different virtualized architectures can be represented in vastly different ways. Certain types of client applications on a remote network management platform or another type of platform may be configured to read data from the CMDB related to virtualized architectures, and use this data for various purposes. This problem is not only visible with on premise virtualization technologies but also on cloud-based virtualization technologies, such as discovery for AWS® and AZURE®. Further, as new cloud-based virtualization technologies are introduced the even more types of relationships are possible.

For instance, a VM inventory application might be configured to identify each discovered VM as well as its host and cluster. In another example, a service mapping application may be configured to identify each discovered VM as well as its host and cluster and then to generate visual representations of the relationships between these configuration items (not unlike the representations of FIG. 7). In yet another example, a software licensing application may compare software installations on discovered VMs with entitlements to this software in order to determine whether the software installations are properly licensed. Notably, it has been observed that just a few CMDB tables per type of visualization architecture—those that store attributes for clusters, hosts, VMs, and the relationships therebetween—typically contain the extent of information needed by these client applications.

Facilitating the successful utilization of each client application requires that it is able to read the appropriate configuration items from the CMDB. Current solutions program the client application with the names of specific CMDB tables and columns therein. These tables and columns store attributes relating to clusters, hosts, VMs, and relationships therebetween for various virtualized architectures. This hardcoded approach, however, is inefficient, as each client application requires a significant amount of updating when new virtualized architectures (and thus new CMDB tables and columns) become supported by discovery procedures and the CMDB.

The embodiments herein overcome these drawbacks and limitations by providing a common interface for identifying the CMDB tables that specify attributes for clusters, hosts, and VMs per virtualized architecture. This common interface may involve scripts, executable code for one or more database queries (e.g., scripts that may include SQL queries of CDMB tables), and/or metadata that provides the mapping. By making use of the common interface, client applications can ingest information relating to any virtualized architecture stored in the CMDB.

### VI. COMMON INTERFACE FOR VIRTUALIZED ARCHITECTURES

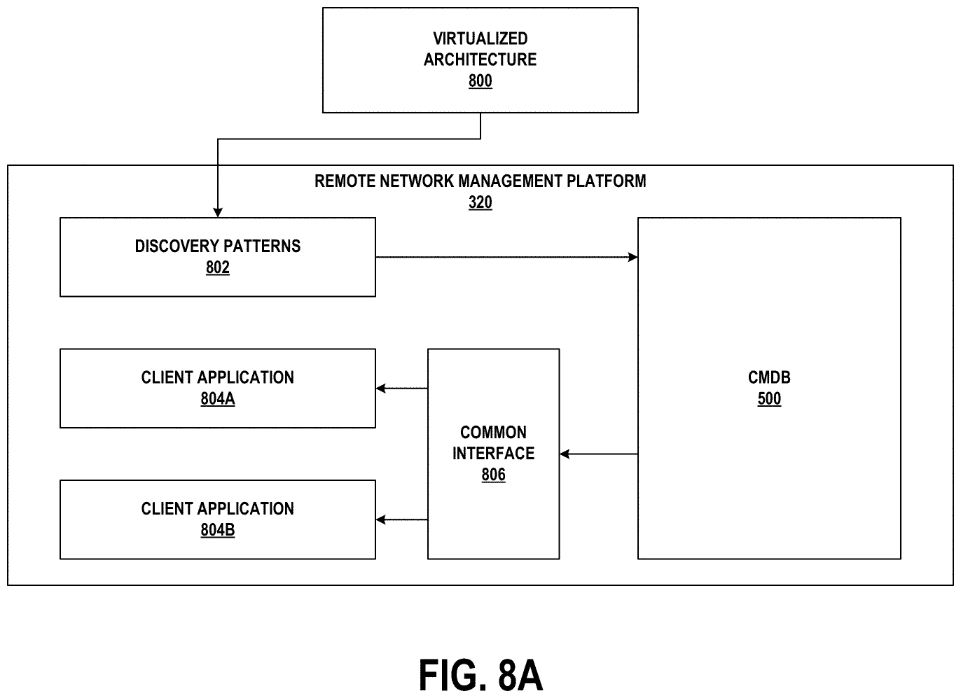

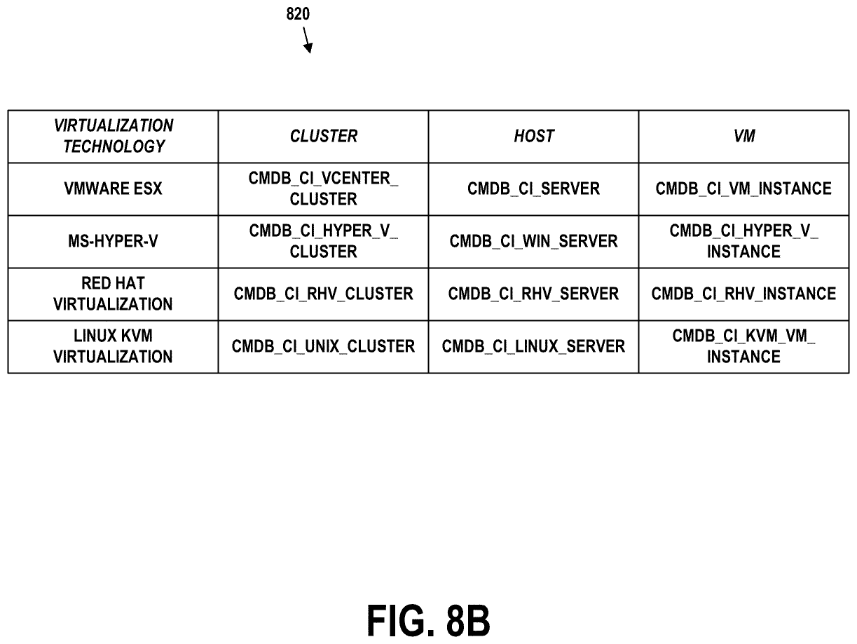

FIG. 8A provides an example of a common interface for interacting with representations of virtualized architectures. Particularly, virtualized architecture 800 may be any of the aforementioned virtualized architectures (e.g., VMware ESX, MS-Hyper-V, Red Hat Virtualization, or Linux KVM Virtualization), or some other virtualized architecture. Further, virtualized architecture 800 may represent two or more different instances of the same or different virtualized architectures that can be discovered. In some embodiments, virtualized architecture 800 may be disposed within a managed network (e.g., managed network 300), and in others virtualized architecture 800 may be disposed within a public cloud system (e.g., one of public cloud networks 340).

To that point, discovery patterns 802 may be invoked or executed by remote network management platform 320 to discover components of virtualized architecture 800. Discovery patterns 802 may store representations of these components and the relationships therebetween in various tables of CMDB 500.

Once these configuration items and relationships are stored, they can be read from CMDB 500, in part or as a whole, by client applications executing on remote network management platform 320. For instance, client application 804A and client application 804B may each read at least some of these configuration items and relationships from CMDB 500. As noted above, client application 804A and client application 804B may be VM inventory applications, service mapping applications, software licensing applications, or some other type of applications. Notably, client application 804A and client application 804B are just two possible client applications and others may exist.

Both client application 804A and client application 804B may retrieve configuration items and relationships from CMDB 500 by way of common interface 806. As noted, common interface 806 may be a set of scripts, and/or metadata that provides a general interface to configuration items and relationships relating to virtualized architectures. In some environments, common interface 806 may be implemented as a REST, simple object access protocol (SOAP), or remote procedure call interface to client applications executing on remote network management platform 320 or other platforms. Herein, common interface 806 is embodied as the aforementioned set of scripts and/or metadata, but one of ordinary skill in the art would understand how it could be implemented in other ways. Further, common interface 806 can be updated dynamically, either in new versions of platform software or by the user.

An illustrative example of common interface 806 and how it might be used follows. FIG. 8B depicts example metadata 820 that identifies, for various virtualization technologies, CMDB tables that store attributes relating to the clusters, hosts within the cluster, and VMs instantiated on the hosts. This metadata may be stored in a file or database table that can be read by the client applications.

For example, for VMware ESX, the cluster attributes are stored in CMDB table cmdb_ci_vcenter_cluster, host attributes are stored in CMDB table cmdb_ci_server, and VM attributes are stored in CMDB table cmdb_ci_vm_instance. Thus, when a client application needs to determine these attributes, it can load metadata 820, identify the virtualization technology of interest (under the “virtualization technology” heading of metadata 820), and then further identify the relevant CMDB tables (under the “cluster”, “host”, and “VM” headings of metadata 820) that contain the attributes related to virtualized architectures using this virtualization technology. Thus, the client application can identify these CMDB tables dynamically and without being explicitly programmed with their names or references thereto.

Common interface 806 may also include one or more scripts that can be executed by the client application or a helper application. These scripts may also be stored in one or more files or in a database. For example, the scripts may search the CMDB tables identified by metadata 820 for a subset of the attributes therein, and provide a listing of these attributes (e.g., using one or more SQL JOIN operations). The scripts may also search the CMDB relationship table(s) to determine relationships between at least some of the configuration items related to the attributes. Again, the client application can identify attributes and relationships dynamically and without being explicitly programmed with their names or references thereto. Generally, the locations specified in metadata 820 may be dynamically applied to the scripts so that the scripts access these locations.

Advantageously, common interface 806 allows any number of client applications to be able to retrieve attributes and relationships associated with configuration items of any number of virtualization technologies. Thus, support for new virtualization technologies can be added to these client applications in a matter of hours or days of development and test time, rather than the weeks or months previously needed for explicit, hardcoded support. Further, to the extent that the CMDB table structure changes for a virtualization technology's configuration items, these changes can be incorporated by modifications to common interface 806 rather than each of the client applications. As a result, there are numerous technical advantages to the use of common interface 806 as described herein, and further advantages may exist.

### VII. EXAMPLE SOFTWARE LICENSING APPLICATION

To further motivate the desirability of the embodiments herein, an example client application that provides software license reconciliation for virtualized architectures is described below. Notably, this is just one possible client application that can take advantage of these embodiments, and other client applications (e.g., VM inventory and service mapping) could also do so.

Even with discovery capabilities, determining whether software applications deployed within a virtualized architecture are properly licensed may become exceptionally complex. Various software applications within such an architecture (e.g., operating systems, productivity software, database software) may be licensed differently based on the type of cluster, as well as the number of hosts, VMs, processors, and/or cores on which they are deployed. The licensing may also take into account options purchased and whether those options include upgrade/downgrade rights. Thus, ensuring that software application deployments are properly licensed in a cost-effective fashion becomes a virtually intractable problem. Further, some software publishers have license compliance rules that are the same regardless of virtualized architecture, while others may have compliance rules that vary with virtualized architectures.

Having too few licenses (under-licensing) is problematic because it can put an enterprise at risk of violating its license agreement with a software vendor and thus be liable for penalty payments. Conversely, having too many licenses (over-licensing) means that the enterprise is overpaying for any extra licenses that it is not using. Thus, active license assessment and management is desirable and should occur on a regular and reasonably frequent basis.

Given the aforementioned complexities, regular manual assessment of licensing usage is not tractable in any but the smallest deployments. Software licensing applications disposed within a remote network management platform can provide mechanisms for automatically discovering software applications deployed across a managed network and/or public cloud system, determining the types of licensing involved, comparing software application usage with entitlements (representations of one or more licenses) to these applications, and providing an assessment of the licensing status of these software applications. This assessment may involve recommendations to obtain more licenses, reduce the number of obtained licenses, change the license type for some installed software applications, remove some of these installations, and/or move some software applications between different types of virtualization (e.g., from hosts to VMs or vice versa).

As described above, discovery procedures may involve a remote network management platform (i.e., a computational instance thereof) querying a virtualized architecture on a managed network by way of a proxy server. Alternatively, other discovery techniques, such as obtaining discovery information from third-party discovery tools, may be used. Either of these techniques allow determination of the extent of deployment, throughout the virtualized architecture, of various software applications. For example, the proxy server may log on to hosts of the virtualized architecture using a remote command shell (e.g., SSH or POWERSHELL®) and execute scripts on these devices that identify software applications. These software applications may be discovered or otherwise identified based on their executable file names and/or the sizes, directory paths, or dates thereof, as well as other factors such as product identifiers that may be found within configuration files. Alternatively, the proxy server may query the virtualized architecture and/or hosts thereof by way of a web-based interface, application-specific interface, or propriety interface. As noted above, virtualized architecture disposed within public cloud systems can be discovered in an analogous fashion.

The information gathered may relate to pre-determined software models, representations of which may also be stored in the CMDB. Such a software model is a definition of a software application. In some cases, it may include a specification of a manufacturer (e.g., a vendor, publisher, or distributor of the software application), a name (e.g., a title of the software application), a version, and an edition. In other cases, more or fewer than these four factors may make up a software model.

As an example, MICROSOFT® Windows Server is a server operating system and suite of software applications. Its publisher is MICROSOFT®, and its title is “Windows Server”. There are numerous versions of this software application, with more recent versions generally named after an approximate year of release, such as “2013”, “2016”, and “2019”. These versions may also be referred with sequentially increasing numerical identifiers, such as “15.0”, “16.0”, and so on. Furthermore, there may be different editions of each version, e.g., Standard, Essentials, and Datacenter. Alternatively, the edition may not be specified, or may be ignored for the purposes herein.

Therefore, the software model for “Microsoft Windows Server 2019 Standard” may refer to the 2019 version of Windows Server from MICROSOFT® that with the Standard feature set. In contrast, the software model for “Microsoft Windows Server 2016 Essentials” may refer to the 2016 version of Windows Server from MICROSOFT® with the Essentials feature set.

Regardless of how information regarding software applications disposed on a virtualized architecture are discovered, these representations may be stored as configuration items in the CMDB. For example, the remote network management platform may compare the discovered representations to software models to identify the discovered software applications and store the representations as configuration items in the CMDB. Configuration items representing software applications may be associated with configuration items represented the virtualized architecture components on which they were discovered. These configuration items may indicate that the computing devices have multiple processors and/or multiple cores per processor, which may impact the licensing of the software applications. Other factors that may impact licensing include the number of CPU sockets and/or amount of disk space for a host.

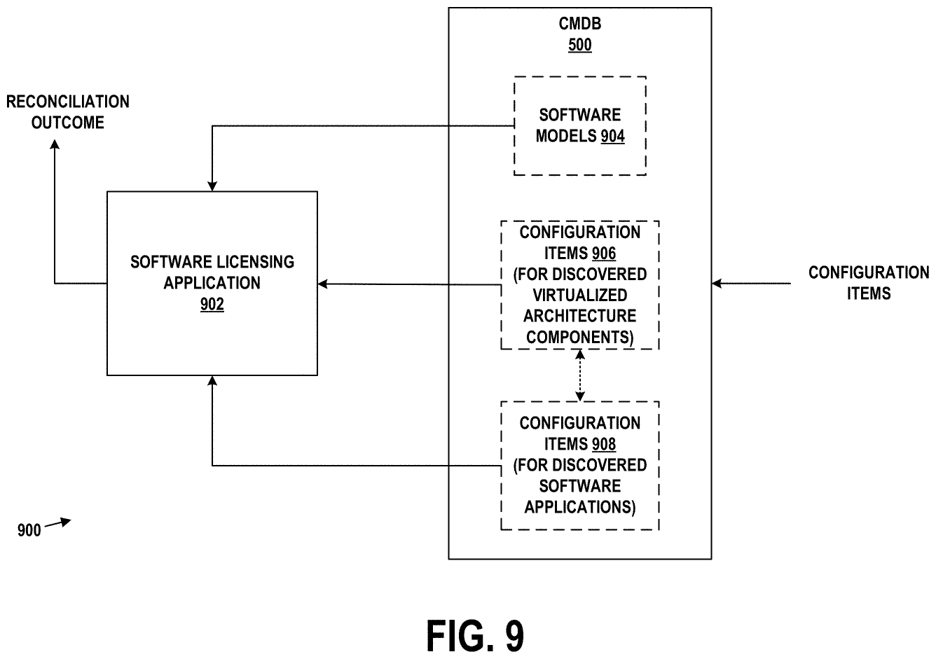

FIG. 9 depicts arrangement 900 of components of a remote network management platform that facilitate this processes. Configuration items are received CMDB 500. These may be stored as configuration items 906 (for discovered virtualized architecture components) and configuration items 908 (for discovered software applications). Discovery procedures may associate configuration items 906 and configuration items 908 with various relationships that indicate which software applications are disposed upon which virtualized architecture components.

Software licensing application 902 may query CMDB 500 to obtain information related to software models 904, configuration items 906, and configuration items 908. Software licensing application 902 may compare these configuration items to software models 904 in order to identify the discovered software applications and reconcile the discovered software applications with entitlements thereto. As a result of this process, software licensing application 902 may produce a reconciliation outcome.

An entitlement can represent one or more software licenses—or other rights of use—for a software application. Thus, each entitlement can include a count of licenses (e.g., 1, 10, 50, etc.), and an entitlement with a count of n may be also referred to as n entitlements. An entitlement can refer to or be associated with a software model to specify the software application being licensed. As an example, 10 entitlements for “Microsoft Windows Server 2019 Standard” may indicate that an enterprise can deploy no more than 10 copies of this software application throughout its managed network while remaining in compliance with these entitlements. In some cases, an enterprise may have several sets of entitlements attached to the same software model—e.g., sets of 10 entitlements, 5 entitlements, and 12 entitlements for “Microsoft Windows Server 2019 Standard”, allowing a maximum deployment of 27 installations. This may reflect how enterprises can obtain entitlements over time on an as-needed basis.

These entitlements may be represented as entries on a database, such as a CMDB. Each entitlement may specify the manufacturer, name, version, and edition of the software that is licensed, as well as the number of licenses and any other features of the license.

To that point, some entitlements and their associated licenses may be portable, while others are not. For example, some software vendors offer license mobility as part of a software assurance package for certain applications. Entitlements with license mobility can be deployed either in the enterprise's managed network or on a cloud platform.

Further, downgrade rights may also be associated with entitlements and/or a software model. These rights specify any previous releases or other editions of a software application or suite to which entitlements for the software model can be applied. For example, entitlements for “Microsoft Windows Server 2019 Standard” may be associated with downgrade rights for “Microsoft Windows Server 2016 Standard”. In other words, each of the entitlements for “Microsoft Windows Server 2019 Standard” may be used for installations of either “Microsoft Windows Server 2019 Standard” or “Microsoft Windows Server 2016 Standard”, but no other versions of this software application. In some cases, downgrade rights may support multiple levels of downgrades and/or multiple paths of downgrades.

Additionally, entitlements may vary in scope based on whether they are applied to an managed network deployments or various public cloud system deployments. For example, one MICROSOFT® SQL Server Enterprise license on-premise might be able to cover four MICROSOFT® SQL Server Standard licenses on AZURE® whereas no such benefit applies on AWS®.

Once deployments of software applications in a managed network and associated cloud platforms are known, and the entitlements to these applications have been determined, a reconciliation process can take place. In this context, reconciliation refers to the act of assigning entitlements to discovered software applications. Various algorithms for doing so by way of software licensing application 902 may exist. A common goal of these algorithms may be to assign the entitlements to installations of the software applications in such a fashion that as many of these installations as possible can be covered by available entitlements. Failing to do so may result in the enterprise finding itself in an under-licensed situation where it has to purchase additional entitlements to cover all installations. Conversely, an ideal assignment may result in the enterprise determining that it is over-licensed and can save money by releasing or not renewing some entitlements. In sum, proper assignment of entitlements to installations can save a large enterprise a significant amount of licensing fees, perhaps on the order or hundreds of thousands or millions of dollars per year.

When it is determined that an enterprise is not in compliance, software licensing application 902 may prompt the user, by way of a graphical user interface, to purchase more entitlements. These purchases may be facilitated by software licensing application 902 and automatically added to the entitlements stored in the database associated with the enterprise. Software licensing application 902 may also prompt the user to convert entitlements without license mobility to having license mobility if the latter would allow the enterprise to attain compliance.

Alternatively, software licensing application 902 may prompt the user to remove unlicensed installations of a software package in the managed network, a public cloud system, or both. If this option is chosen, software licensing application 902 may transmit commands to the managed network and/or the applicable public cloud system to do so.

If the enterprise is over-licensed, the remote network management platform may suggest, by way of a graphical user interface, releasing, downgrading, or not renewing certain licenses. The cost of each of these possibilities may be presented therewith, and in some cases the recommendations may be made based on the goal of minimizing cost while maintaining compliance of entitlements.

Further, software licensing application 902 may allow the user to enter, by way of a graphical user interface, hypothetical scenarios and then provide options for licensing. Again, the goal may be for these options to minimize cost. In each case, the enterprise may enter one or more constraints with which the licensing options must comply, if possible.

### VIII. EXAMPLE OPERATIONS

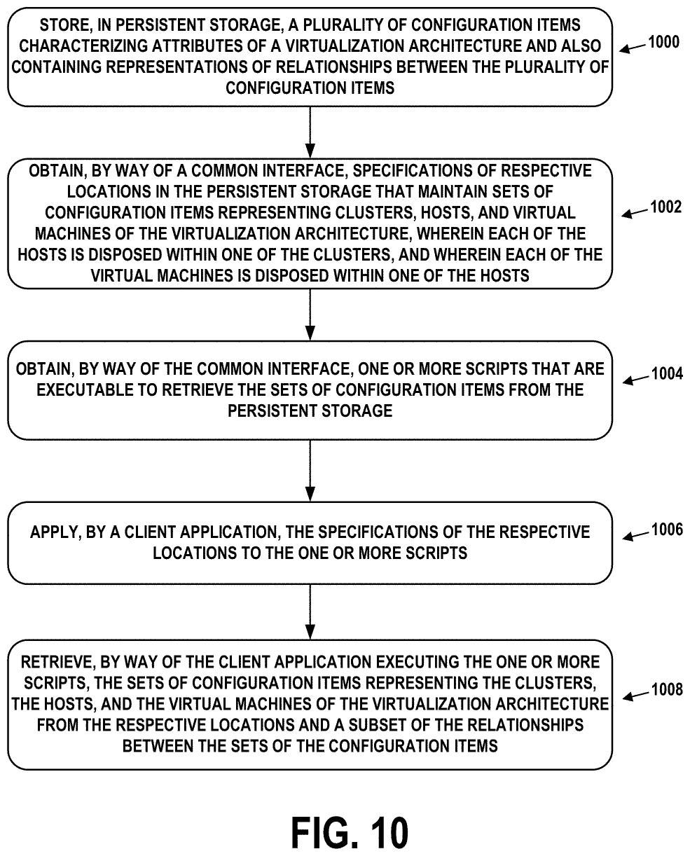

FIG. 10 is a flow chart illustrating an example embodiment. The process illustrated by FIG. 10 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 10 may be simplified by the removal of any one or more of the features shown therein. Further, these embodiments may be combined with features, aspects, and/or implementations of any of the previous figures or otherwise described herein.

Block 1000 may involve storing, in persistent storage, a plurality of configuration items characterizing attributes of a virtualized architecture and also containing representations of relationships between the plurality of configuration items.

Block 1002 may involve obtaining, by way of a common interface, specifications of respective locations in the persistent storage that maintain sets of configuration items representing clusters, hosts, and virtual machines of the virtualized architecture, wherein each of the hosts is disposed within one of the clusters, and wherein each of the virtual machines is disposed within one of the hosts.

Block 1004 may involve obtaining, by way of the common interface, one or more scripts that are executable to retrieve the sets of configuration items from the persistent storage.

Block 1006 may involve applying, by a client application, the specifications of the respective locations to the one or more scripts.

Block 1008 may involve retrieving, by way of the client application executing the one or more scripts, the sets of configuration items representing the clusters, the hosts, and the virtual machines of the virtualized architecture from the respective locations and a subset of the relationships between the sets of the configuration items.

In some embodiments, the persistent storage also contains a further plurality of configuration items characterizing further attributes of a further virtualized architecture and also containing further representations of further relationships between the further plurality of configuration items. These embodiments may further involve: obtaining, by way of the common interface, further specifications of further respective locations in the persistent storage that maintain further sets of configuration items representing further clusters, further hosts, and further virtual machines of the further virtualized architecture, wherein each of the further hosts is disposed within one of the further clusters, and wherein each of the further virtual machines is disposed within one of the further hosts; obtaining, by way of the common interface, one or more further scripts that are executable to retrieve the further sets of configuration items from the persistent storage; applying, by the client application, the further specifications of the further respective locations to the one or more further scripts; and retrieving, by way of the client application executing the one or more further scripts, the further sets of configuration items representing the further clusters, the further hosts, and the further virtual machines of the further virtualized architecture from the further respective locations and a further subset of the further relationships between the further sets of the configuration items.

Some embodiments may further involve: applying, by a second client application, the specifications of the respective locations to the one or more scripts; and retrieving, by way of the second client application executing the one or more scripts, the sets of configuration items representing the clusters, the hosts, and the virtual machines of the virtualized architecture from the respective locations and the subset of the relationships between the sets of the configuration items.

In some embodiments, the client application is not configured to be aware of the respective locations until they are obtained by way of the common interface.

In some embodiments, the client application is a software licensing application. These embodiments may further involve determining, by way of the client application and from the sets of configuration items and the subset of the relationships, whether software applications installed within the clusters are in compliance with a set of entitlements to the software applications.

In some embodiments, the client application is a virtual machine inventory application. These embodiments may further involve determining, by way of the client application and from the sets of configuration items and the subset of the relationships, a count and an arrangement of the virtual machines.

In some embodiments, the client application is a service mapping application. These embodiments may further involve determining, by way of the client application and from the sets of configuration items and the subset of the relationships, a visually-displayable hierarchical representation of the clusters, the hosts, and the virtual machines.

In some embodiments, the persistent storage includes a database, wherein the respective locations in the persistent storage include tables of the database or columns in the tables of the database. The one or more scripts may include database query language scripts. The common interface provides a mapping between the respective locations and generic references to the clusters, the hosts, and the virtual machines.

### IX. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, or compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
persistent storage containing a plurality of configuration items characterizing attributes of a virtualized architecture and also containing representations of relationships between the plurality of configuration items, wherein the virtualized architecture is disposed within a managed network or a public cloud computing system; and
one or more processors configured to:
obtain, by way of a common interface, specifications of respective locations in the persistent storage that maintain sets of configuration items representing clusters, hosts, and virtual machines of the virtualized architecture, wherein each of the hosts is disposed within one of the clusters, and wherein each of the virtual machines is disposed within one of the hosts;
obtain, by way of the common interface, one or more scripts that are executable to retrieve the sets of configuration items from the persistent storage;
apply, by a client application, the specifications of the respective locations to the one or more scripts; and
retrieve, by way of the client application executing the one or more scripts, the sets of configuration items representing the clusters, the hosts, and the virtual machines of the virtualized architecture from the respective locations and a subset of the relationships between the sets of the configuration items.

2. The system of claim 1, wherein the persistent storage also contains a further plurality of configuration items characterizing further attributes of a further virtualized architecture and also containing further representations of further relationships between the further plurality of configuration items, and wherein the one or more processors are further configured to:
obtain, by way of the common interface, further specifications of further respective locations in the persistent storage that maintain further sets of configuration items representing further clusters, further hosts, and further virtual machines of the further virtualized architecture, wherein each of the further hosts is disposed within one of the further clusters, and wherein each of the further virtual machines is disposed within one of the further hosts;
obtain, by way of the common interface, one or more further scripts that are executable to retrieve the further sets of configuration items from the persistent storage;
apply, by the client application, the further specifications of the further respective locations to the one or more further scripts; and
retrieve, by way of the client application executing the one or more further scripts, the further sets of configuration items representing the further clusters, the further hosts, and the further virtual machines of the further virtualized architecture from the further respective locations and a further subset of the further relationships between the further sets of the configuration items.

3. The system of claim 1, wherein the one or more processors are further configured to:
apply, by a second client application, the specifications of the respective locations to the one or more scripts; and
retrieve, by way of the second client application executing the one or more scripts, the sets of configuration items representing the clusters, the hosts, and the virtual machines of the virtualized architecture from the respective locations and the subset of the relationships between the sets of the configuration items.

4. The system of claim 1, wherein the client application is not configured to be aware of the respective locations until they are obtained by way of the common interface.

5. The system of claim 1, wherein the client application is a software licensing application, and wherein the one or more processors are further configured to:
determine, by way of the client application and from the sets of configuration items and the subset of the relationships, whether software applications installed within the clusters are in compliance with a set of entitlements to the software applications.

6. The system of claim 1, wherein the client application is a virtual machine inventory application, and wherein the one or more processors are further configured to:
determine, by way of the client application and from the sets of configuration items and the subset of the relationships, a count and an arrangement of the virtual machines.

7. The system of claim 1, wherein the client application is a service mapping application, and wherein the one or more processors are further configured to:
determine, by way of the client application and from the sets of configuration items and the subset of the relationships, a visually-displayable hierarchical representation of the clusters, the hosts, and the virtual machines.

8. The system of claim 1, wherein the persistent storage includes a database, and wherein the respective locations in the persistent storage include tables of the database or columns in the tables of the database.

9. The system of claim 8, wherein the one or more scripts include database query language scripts.

10. The system of claim 8, wherein the common interface provides a mapping between the respective locations and generic references to the clusters, the hosts, and the virtual machines.

11. A computer-implemented method comprising:
storing, in persistent storage, a plurality of configuration items characterizing attributes of a virtualized architecture and also containing representations of relationships between the plurality of configuration items;
obtaining, by way of a common interface, specifications of respective locations in the persistent storage that maintain sets of configuration items representing clusters, hosts, and virtual machines of the virtualized architecture, wherein each of the hosts is disposed within one of the clusters, and wherein each of the virtual machines is disposed within one of the hosts;
obtaining, by way of the common interface, one or more scripts that are executable to retrieve the sets of configuration items from the persistent storage;
applying, by a client application, the specifications of the respective locations to the one or more scripts; and
retrieving, by way of the client application executing the one or more scripts, the sets of configuration items representing the clusters, the hosts, and the virtual machines of the virtualized architecture from the respective locations and a subset of the relationships between the sets of the configuration items.

12. The computer-implemented method of claim 11, further comprising:
applying, by a second client application, the specifications of the respective locations to the one or more scripts; and
retrieving, by way of the second client application executing the one or more scripts, the sets of configuration items representing the clusters, the hosts, and the virtual machines of the virtualized architecture from the respective locations and the subset of the relationships between the sets of the configuration items.

13. The computer-implemented method of claim 11, wherein the client application is not configured to be aware of the respective locations until they are obtained by way of the common interface.

14. The computer-implemented method of claim 11, wherein the client application is a software licensing application, the computer-implemented method further comprising:
determining, by way of the client application and from the sets of configuration items and the subset of the relationships, whether software applications installed within the clusters are in compliance with a set of entitlements to the software applications.

15. The computer-implemented method of claim 11, wherein the client application is a virtual machine inventory application, the computer-implemented method further comprising:
determining, by way of the client application and from the sets of configuration items and the subset of the relationships, a count and an arrangement of the virtual machines.

16. The computer-implemented method of claim 11, wherein the client application is a service mapping application, the computer-implemented method further comprising:
determining, by way of the client application and from the sets of configuration items and the subset of the relationships, visually-displayable hierarchical representation of the clusters, the hosts, and the virtual machines.

17. The computer-implemented method of claim 11, wherein the persistent storage includes a database, and wherein the respective locations in the persistent storage include tables of the database or columns in the tables of the database.

18. The computer-implemented method of claim 17, wherein the one or more scripts include database query language scripts.

19. The computer-implemented method of claim 17, wherein the common interface provides a mapping between the respective locations and generic references to the clusters, the hosts, and the virtual machines.

20. An article of manufacture including a non-transitory computer-readable medium, having stored thereon program instructions that, upon execution by a computing system, cause the computing system to perform operations comprising:
storing, in persistent storage, a plurality of configuration items characterizing attributes of a virtualized architecture and also containing representations of relationships between the plurality of configuration items;
obtaining, by way of a common interface, specifications of respective locations in the persistent storage that maintain sets of configuration items representing clusters, hosts, and virtual machines of the virtualized architecture, wherein each of the hosts is disposed within one of the clusters, and wherein each of the virtual machines is disposed within one of the hosts;
obtaining, by way of the common interface, one or more scripts that are executable to retrieve the sets of configuration items from the persistent storage;
applying, by a client application, the specifications of the respective locations to the one or more scripts; and
retrieving, by way of the client application executing the one or more scripts, the sets of configuration items representing the clusters, the hosts, and the virtual machines of the virtualized architecture from the respective locations and a subset of the relationships between the sets of the configuration items.
